(19) United States
(12) Patent Application Publication
(10) Pub. No.: US 2003/0079381 A1
(43) Pub. Date: May 1, 2003

(54) License plate frame and accent bar having customizing logos

(76) Inventors: Susanne Arens, Colorado Springs, CO (US); Todd Spencer, Colorado Springs, CO (US)

Correspondence Address: Timothy T. Tyson, Freilich, Hornbaker & Rosen, Suite 1220, 10960 Wilshire Blvd., Los Angeles, CA, 90024, US

(21) Appl. No.: 10/055,166

(22) Filed: Oct. 29, 2001

(51) Int. Cl. G09F 7/00

(52) U.S. Cl. 40/210

(57) ABSTRACT

A stock license plate frame (20) is shown having a customizing logo (38) and trademarks (40). Attachment holes (42, 44, 46, and 48) are provided in the top and bottom cross members (22 and 24). The logo (33) and trademark (40) are mounted on plates (39) having pin 41, 43, 47, and 49) on the back which fit into holes in the frame. Retainer clips (64) pushed onto the pins help retain the logo and trademark on the frame. An accent bar (50) is also shown constructed in the same manner which fits over only the top or bottom of a license plate,

### TECHNICAL FIELD

The present invention relates generally to the field of vehicle license plate decorations, and more particularly to standard license plate frames and accent bars which can be customized by customizing logos and trademarks.

### BACKGROUND ART

It has long been desirable to customize license plate frames for vehicles with metal or plastic frames around and/or over the periphery of the license plates. Each frame is fabricated with a particular set format which may include designs, blank portions, logos, and/or trademarks. The blank portions are provided on many frames so they may be engraved with custom messages or provide smooth surfaces for letters and logos having adhesive backings. No method has been available for a stock frame to be customized with specializing logos and trademark so that it looks like a unitary frame. Instead dealers in license plate frames have to stock a multiplicity of frames to meet the varied demands of their customers.

### DISCLOSURE OF INVENTION

The present invention is directed to a stock license plate frame having customizing logos and/or trademarks. A relatively unadorned frame is provided with attachment holes on the top and/or bottom cross members. A logo and/or trademark are on a separate plate of metal or plastic having at least one pin on the back which fits into one or more holes in the frame. The logo and/or trademark is secured to the frame by pushing the at least one pin into a hole in the frame.

In accordance with an important feature of the invention, at least two holes are provide in one or both of the top and bottom cross members of the frame and at least two pins are provide on the back of the plate having the logo and/or trademark. Then when the logo and/or trademark is attached to the frame, it is less likely to twist on the frame than if it had only one pin.

In accordance with another important feature of the invention, the plate having the logo and/or trademark has a skirt which fits around a portion of the profile of the top or bottom member of the frame. Then when the logo and/or trademark is attached to the frame, it is less likely to twist on the frame than if it had only one pin. Also, the skirt can further dress up the embellishment of the frame.

In accordance with another important feature of the invention, a retainer clip is pushed onto each pin after the logo and/or trademark is pushed onto the frame to further secure the logo and/or trademark on the frame.

In accordance with another preferred embodiment of the invention, the frame does not extend around the periphery oh the license plate. Instead only the top and/or bottom of the license is covered by a bar. The bar has at least one hole for accepting a customizing logo and/or trademark.

Other features and advantages of the present invention will become apparent from the following detailed description, taken in conjunction with the accompanying drawings, which illustrate, by way of example, the principles of the invention.

### BRIEF DESCRIPTION OF DRAWINGS

FIG. 1 is front elevation view of a license plate frame having a customizing logo and trademark in accordance with the present invention;

FIG. 2 is a front elevation vie of an accent bar for the top or bottom of a license plate;

FIG. 3 is a front elevation view similar to FIG. 1 prior to installation of the customizing logo and trademark;

FIG. 4 is a top, front, right side perspective view of an accent bar as the customizing Logo is about to be installed;

FIG. 5 is a right side elevation view of FIG. 4;

FIG. 6 is a top plan view of the customizing logo;

FIG. 7 is a right side elevation view of FIG. 1;

FIG. 8 is a top plan view of FIGS. 1 and 2;

FIG. 9 is a front elevation view of another embodiment similar to FIG. 1;

FIG, 10 is a top, front, right side perspective view of another embodiment;

FIG. 11 is another front elevation view of the embodiment of FIG. 1;

FIG. 12 is a front, bottom, right side perspective view of the embodiment of FIG. 1;

FIG. 13 is a front, bottom, right side perspective view of the embodiment of FIG. 1 prior to installation of the customizing logo and trademark;

FIG. 14 is another front elevation view of the accent bar of FIG. 2;

FIG. 15 is a top, front, right side perspective view of the accent bar of FIG. 2;

FIG. 16 is a top, front, right side perspective view similar to FIG. 12; and,

FIG. 17 is a top, front, right side perspective view similar to FIG. 16 prior to installation of the customizing logo.

### MODES FOR CARRYING OUT THE INVENTION

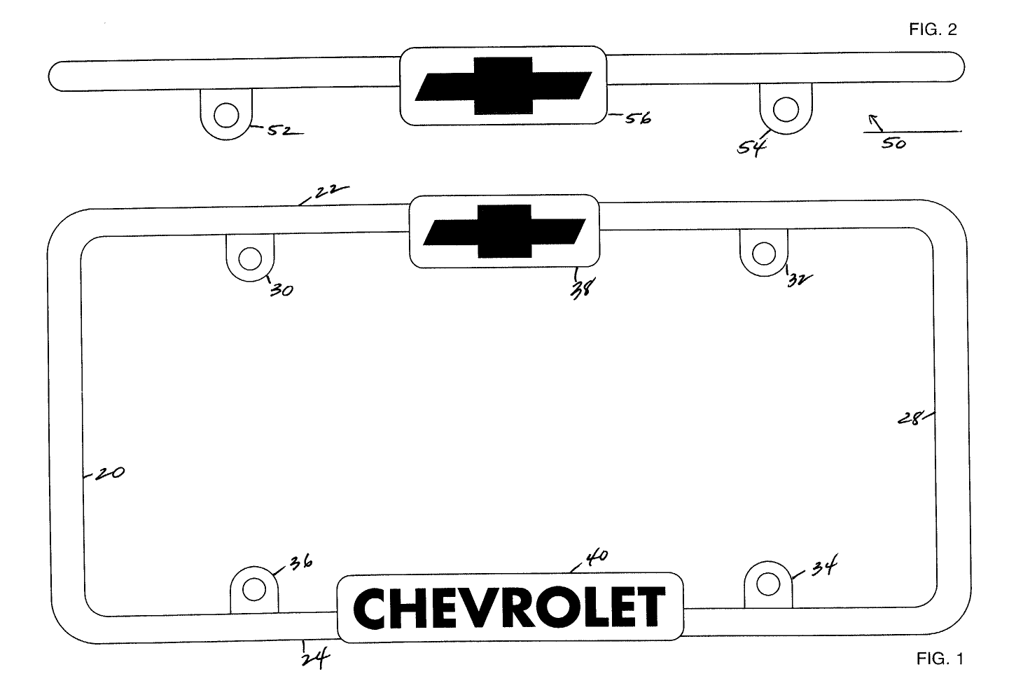

Referring initially to FIG. 1, a front elevation view of a license plate frame having a customizing logo and trademark in accordance with the present invention is shown in accordance with the present invention, generally designated 20. The frame 20 has top and bottom cross members 22 and 24, respectively, right and left sides 26 and 28, respectively, mounting loops 30, 32, 34, and 36 for mounting the frame in front of a vehicle license plate frame, a logo 38, and a trademark 40.

FIG. 2 is a front elevation view of an accent bar 50 for the top or bottom of a license plate. Instead of going completely around a license plate, the accent bar is mounted only on the top or bottom of a license plate, otherwise, it is made in the same manner as a license plate frame, The accent bar 50 has mounting loops 52 and 54 for mounting the accent bar and a logo 56.

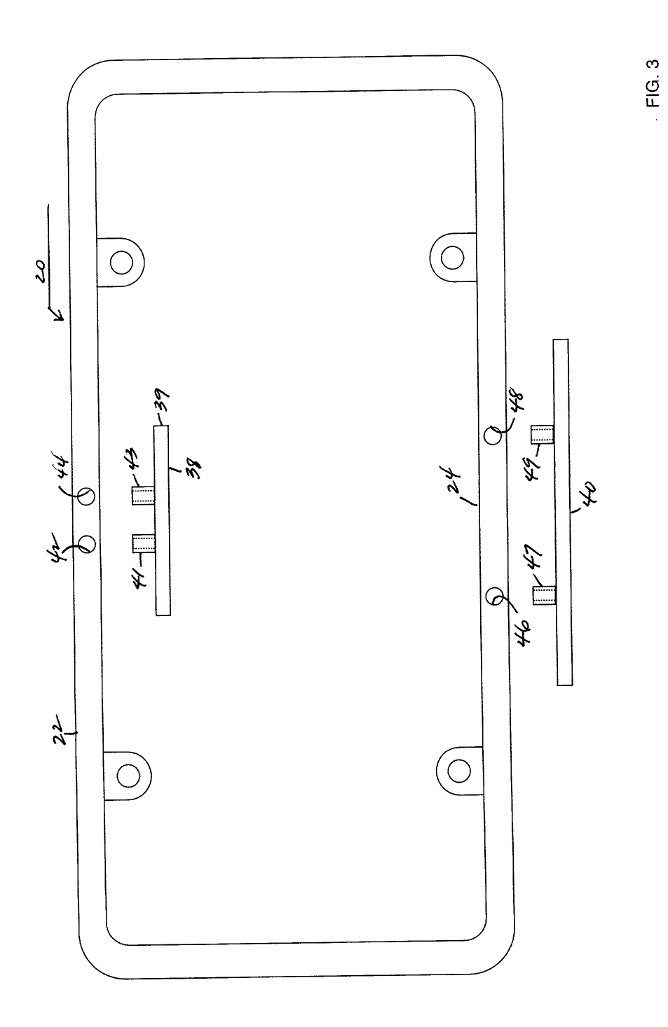

FIG. 3 is a front elevation view of frame 20 similar to FIG. 1 prior to installation of the customizing logo and trademark. The top cross member 22 has two holes 42 and 44 in the middle for mounting the logo. The bottom cross member 24 also has two hole 46 and 48 for mounting the trademark 40. The logo 38 is mounted on a plate 39 having two pins 41 and 43 on the back. The trademark 40 is also mounted on a plate 45 having two pins 47 and 49 on the back. The frame shown in FIG. 1 is assembled by inserting the pins 41 and 43 of the logo 38 into the two holes 42 and 44 in the top cross member 22 and by inserting the pins 47 and 49 of the trademark 40 into the two holes 46 and 48 in the bottom cross member 24.

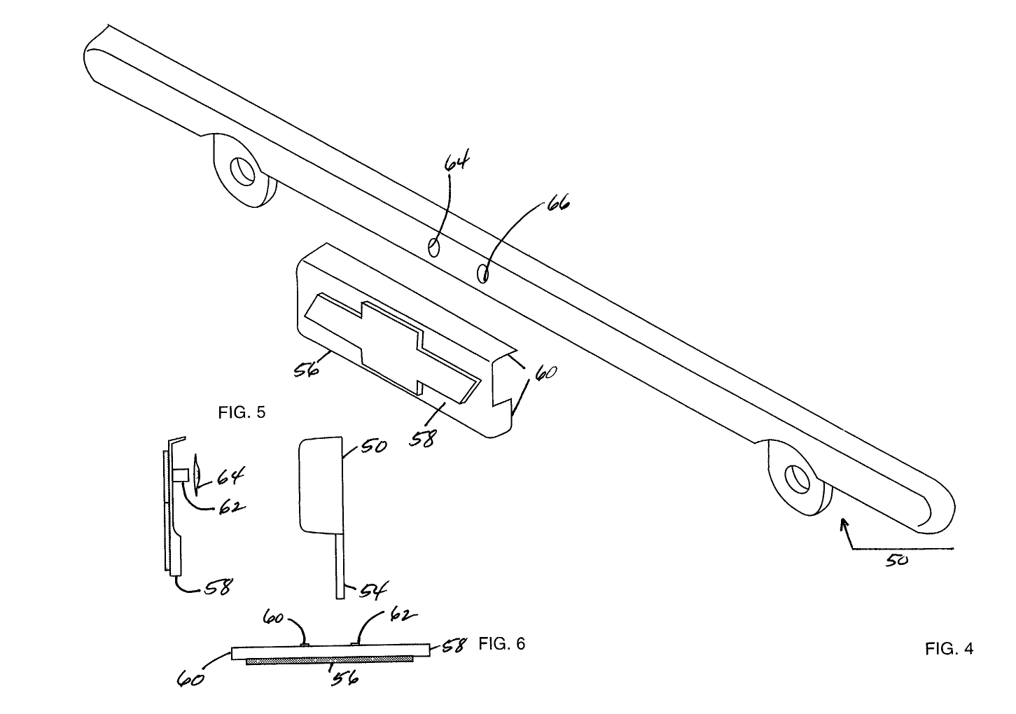

FIG. 4 is a top, front, right side perspective view of the accent bar 50 as the customizing logo 56 is about to be installed. The logo 56 is mounted on a plate 58 having a skirt 60 which matches the profile of the bar 50 after it is installed. By matching the profile, the skirt 60 restricts the ability of the logo to rotate on the bar 50 and also dresses up the resulting combination so that the assembled accent bar looks like a unitary product. On the back of the plate are two pins 62 and 64 similar to pins 41 and 43 of FIG. 3. See also FIG. 5. By

FIG. 5 is a right side elevation view of FIG. 4. The bar 50 has a thin mounting loop 54 for attachment by a bolt to a license plate holder on vehicle. One 62 of the two pins on the back to the plate 58 holding the logo is shown. The bar 50 has two holes 64 and 66 for attaching the logo. The logo 56 is secured to the bar 50 by pushing the pin 62 into the hole 66 along with the second pin which cannot be see which goes into hole 64. After the pins are pushed into the holes, metal retainers 64 are pushed over the pins to secure them into place. It is noted in FIG. 5 that the pin 62 is shorter that the thickness of the bar 50 shown to the right. This is possible because bar 50 is not solid but is instead hollowed out in the back in a manner well known in the art.

FIG. 6 is a top plan view of the customizing logo 56 mounted on the plate 58. Pin 62 and the other pin 66 are barely visible behind the skirt 60.

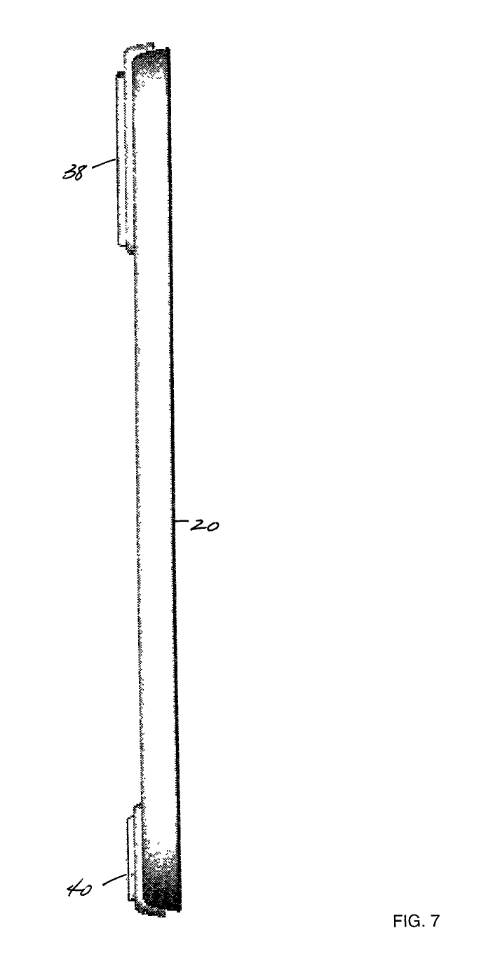

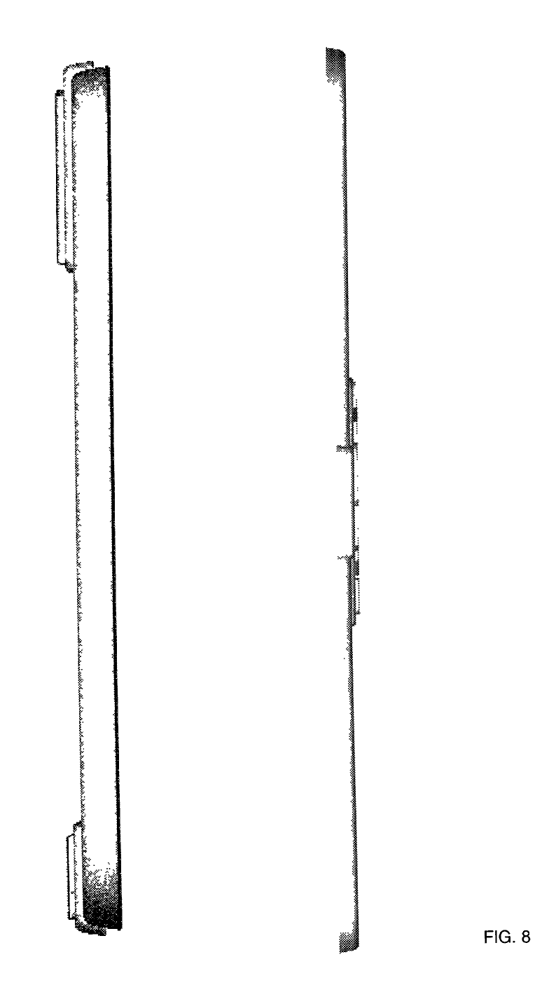

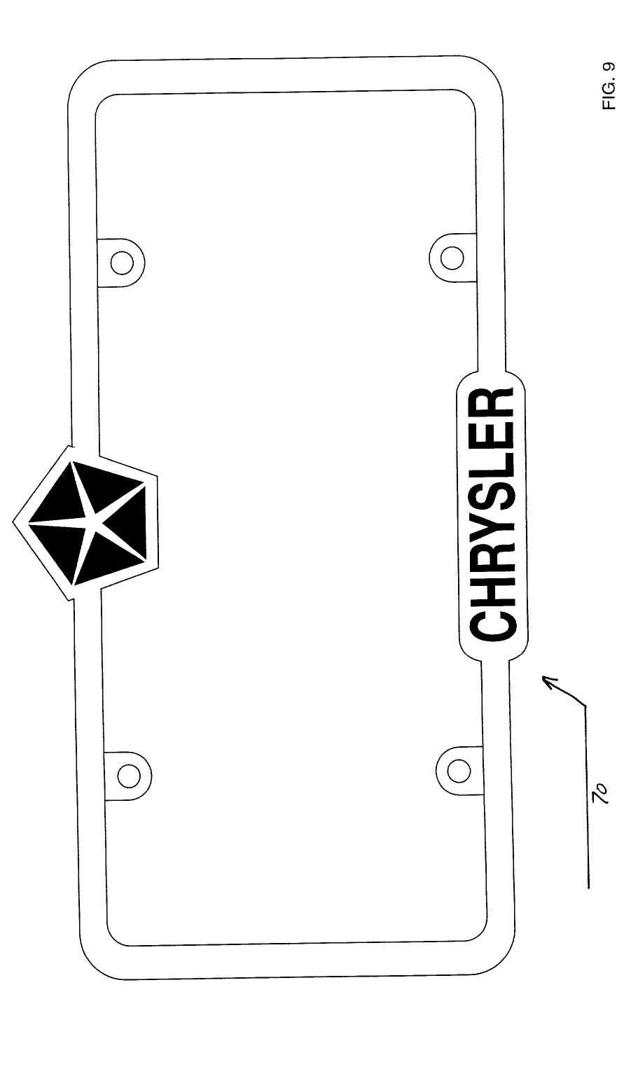

FIG. 7 is a right side elevation view of the frame 20 or FIG. 1. Logo 38 and trademark 40 are securely attached to the frame.

FIG. 8 is a top plan view of FIGS. 1 and 2. The frame 20 and accent bar 50 look the same from the top.

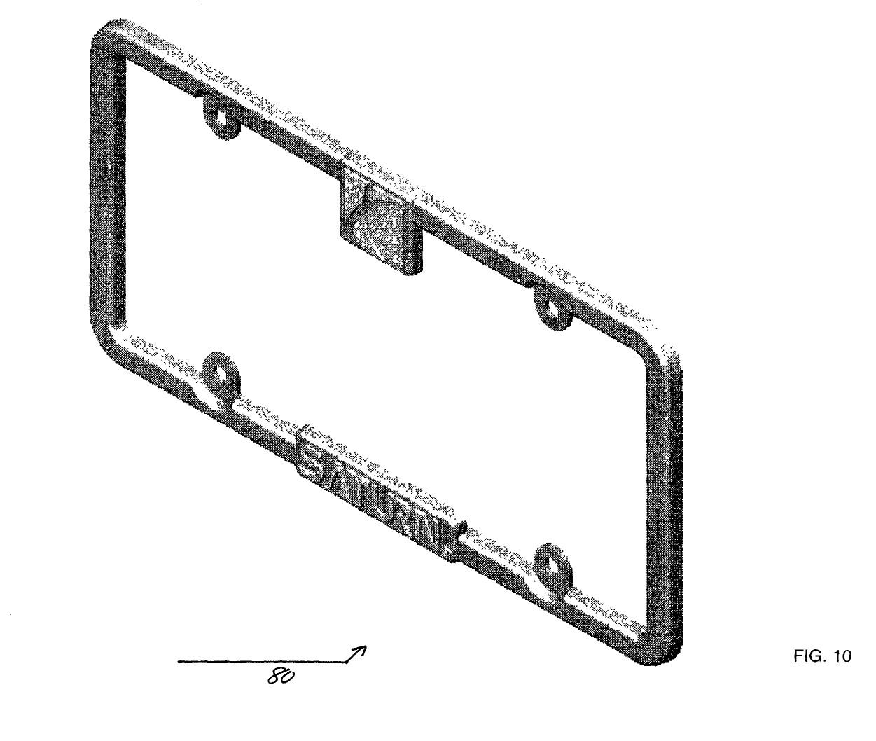

FIG. 9 is a front elevation view of another embodiment 70 similar to FIG. 1.

FIG. 10 is a top, front, right side perspective view of another embodiment 80.

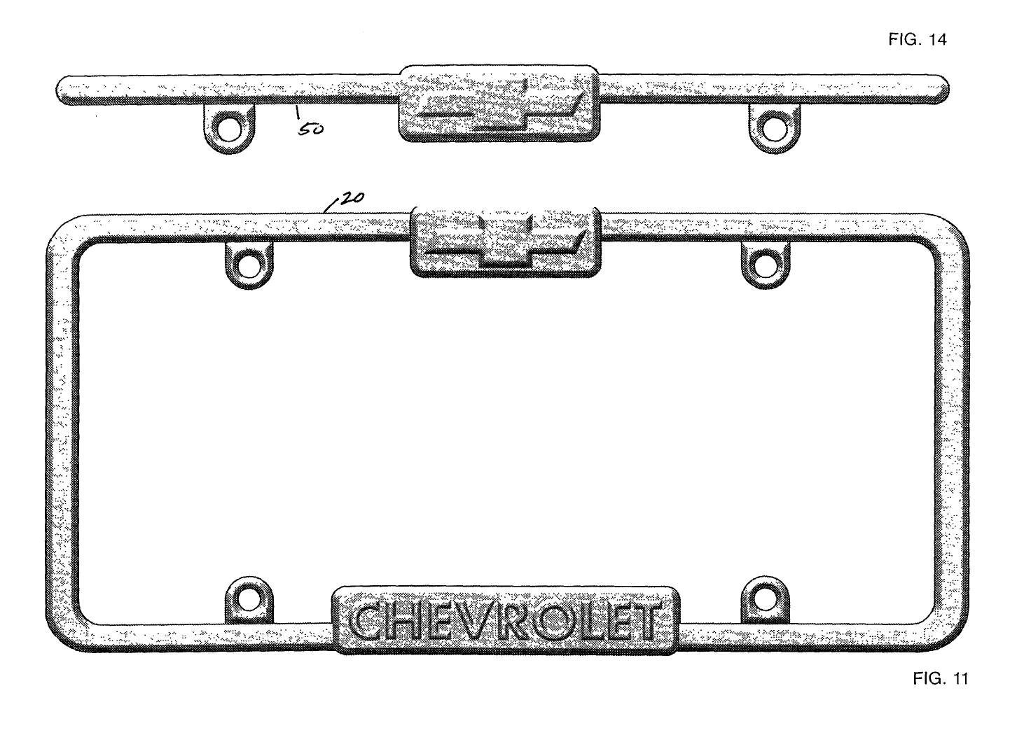

FIG. 11 is another front elevation view of the embodiment of the frame 20 of FIG. 1.

FIG. 12 is a front, bottom, right side perspective view of the embodiment of the frame 20 of FIG. 1.

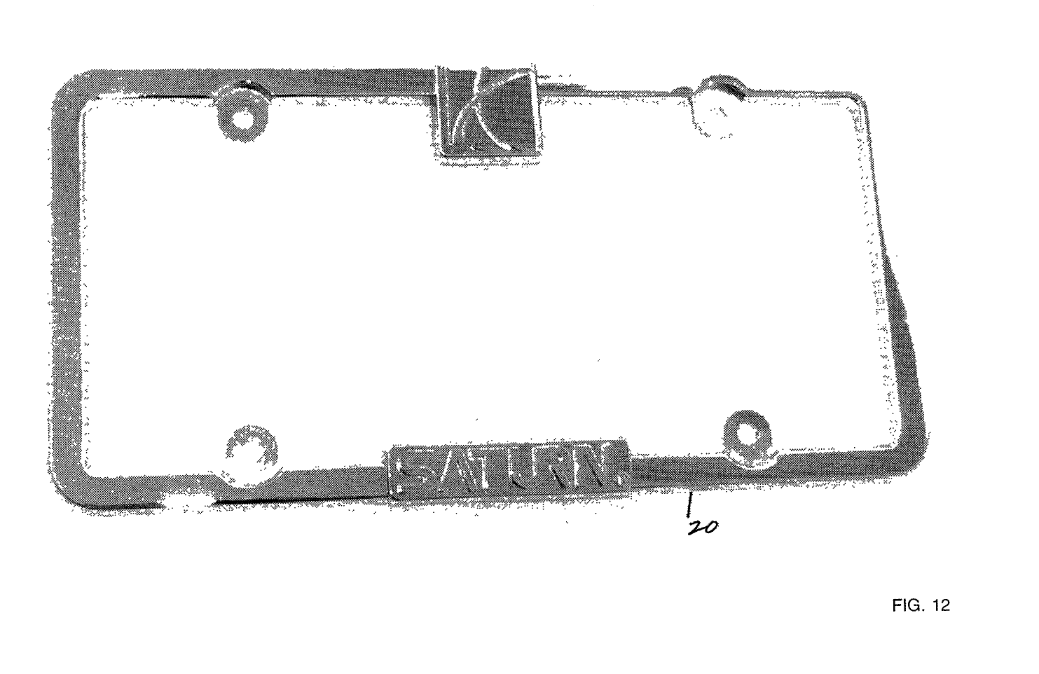

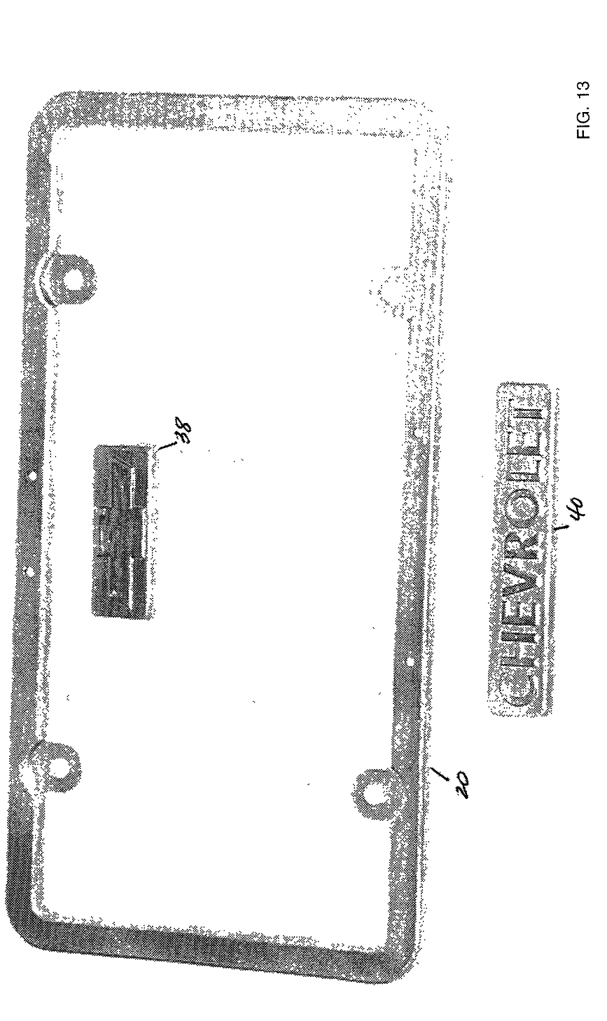

FIG. 13 is a fronts bottom, right side perspective view of the embodiment of the frame 20 of FIG. 1 prior to installation of the customizing logo 38 and trademark 40.

FIG. 14 is another front elevation view of the accent bar 50 of FIG. 2.

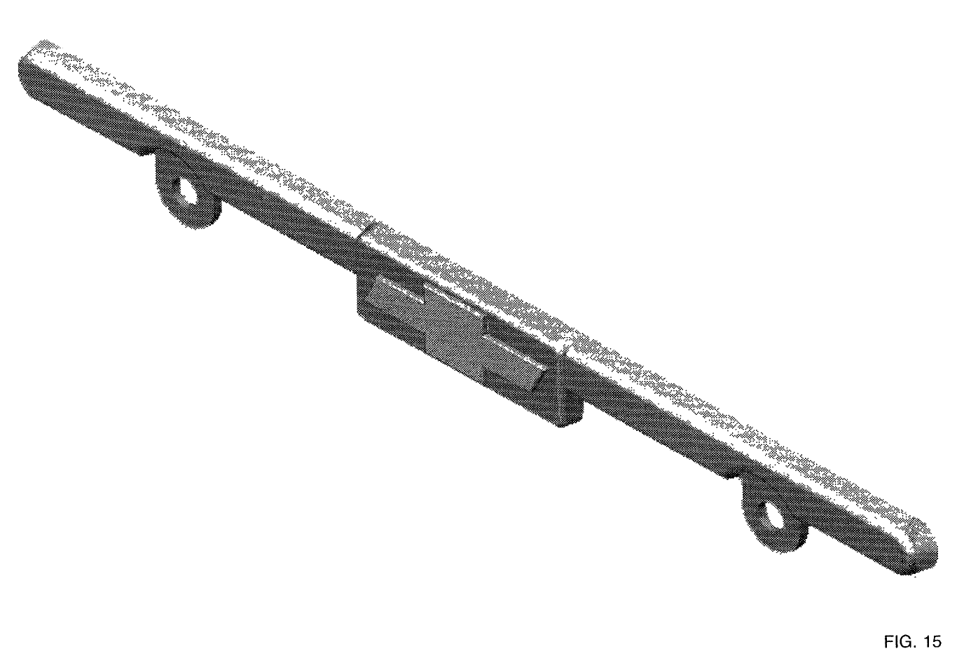

FIG. 15 is a top, front, right side perspective view of the accent bar 50 of FIG. 2.

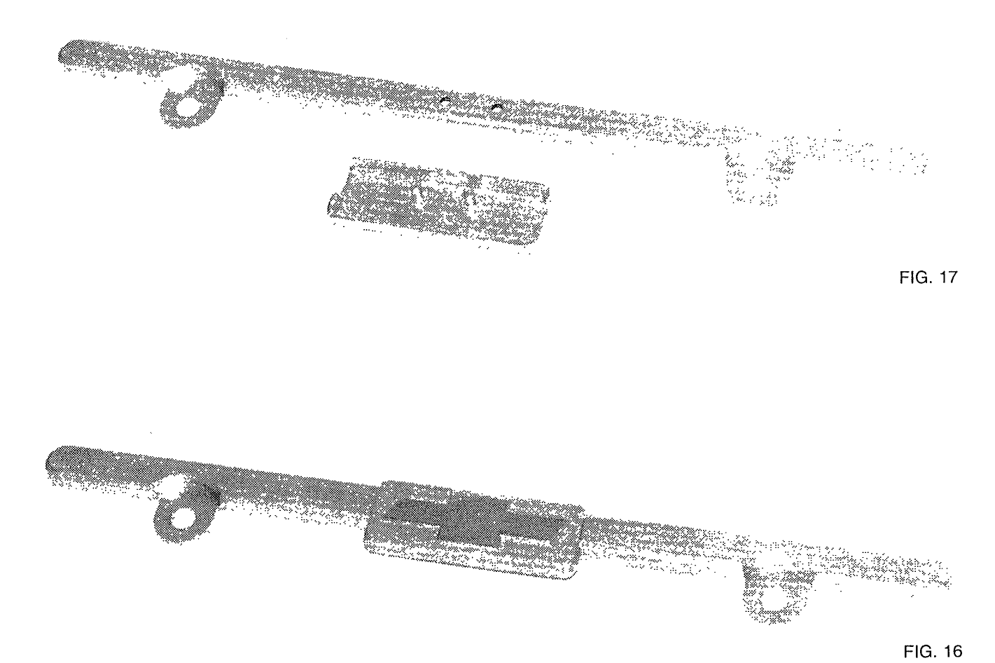

FIG. 16 is a top, front, right side perspective view of the accent bar 50 similar to FIG. 12.

FIG. 17 is a top, front, right side perspective view of the accent bar 50 similar to FIG. 16 prior to installation of the customizing logo 56.

By providing standardized frames and accent bars, the dealers who stock these items need to have only one style of each instead of dozens of different styles. Of course, more than one material or color could be stocked. For example, brass, steel, white, and black in metal and plastic have been found to create desirable appearances. Others are also possible such as green and red for special occasions. The customer then selects the logo or trademark he want to customize his frame or accent bar. Hundreds of logos, trademarks, designs, and short phrases can be made available at low cost for this purpose. The dealer is thereby able to offer a much wider selection than would be possible if he had to stock completed frames which might never sell.

The preferred embodiments of the invention described herein are exemplary and numerous modifications, dimensional variations, and rearrangements can be readily envisioned to achieve an equivalent result, all of which are intended to be embraced within the scope of the appended claims.

We claim:

1. A license plate frame having customizing logos and/or trademarks, comprising:
a frame having at least one attachment hole in at least one of a top and bottom cross members; and,
at least one logo or trademark on a plate having at least one pin on the back fitted into said at least one attachment hole.

2. A license plate frame in accordance with claim 1, wherein said at least one attachment holes is at least two holes and said at least one pin is two pins so that when the logo and/or trademark is attached to the frame it cannot twist on the frame.

3. A license plate frame in accordance with claim 1, further including said plate having a skirt fitted around at least a portion of the profile of the top or bottom member of the frame so that said logo and/or trademark cannot twist on the frame.

4. A license plate frame in accordance With claim 1, further including a retainer clip on each of said at least one pin securing said logo and/or trademark an said frame.

5. An accent bar for a license plate, comprising:
a horizontal bar having at least one hole; and,
at least one logo or trademark on a plate having at least one pin on the back fitted into said at least one attachment hole.
